(19) United States
(12) Patent Application Publication
(10) Pub. No.: US 2025/0393010 A1
(43) Pub. Date: Dec. 25, 2025

(54) METHOD OF ACCESS AND MOBILITY MANAGEMENT FUNCTION (AMF), METHOD OF USER EQUIPMENT (UE), AMF, AND UE

(71) Applicant: NEC Corporation, Minato-ku, Tokyo (JP)

(72) Inventors: Prabhu KALIYAMMAL THIRUVASAGAM, Tokyo (JP); Hiroshi DEMPO, Tokyo (JP); Iskren IANEV, Tokyo (JP); Toshiyuki TAMURA, Ibaraki (JP); Kundan TIWARI, Tokyo (JP); Kengo TAKEBAYASHI, Tokyo (JP)

(73) Assignee: NEC Corporation, Minato-ku, Tokyo (JP)

(21) Appl. No.: 18/876,714

(22) PCT Filed: Jul. 26, 2023
(86) PCT No.: PCT/JP2023/027373

§ 371 Date: Dec. 19, 2024

(30) Foreign Application Priority Data
Aug. 4, 2022 (IN) 202211044606

(51) Int. Cl. H04W 60/06; H04W 60/04

(52) U.S. Cl. CPC H04W 60/06; H04W 60/04

(57) ABSTRACT

An aspect of this disclosure includes a method of an Access and Mobility Management Function (AMF) in a network that provides access to a localized service. The method includes: performing registration with a plurality of User Equipments (UEs) for the localized service; and controlling a deregistration of part of the plurality of UEs, in a case where the localized service is ended.

### TECHNICAL FIELD

The present disclosure relates to a method performed by a communication apparatus, a method performed by a User Equipment (UE), a communication apparatus, and a UE.

### BACKGROUND ART

The 3rd Generation Partnership Project (3GPP) Service and System Aspects Working Group 2 (SA2) is working to study further enhancements of the 5G System (5GS) to support Non-Public Networks (NPNs). Specifically, the SA2 NPN Study Item aims to address SA1 requirements specified in TS 22.261 (NPL 4) related to support for Providing Access to Localized Services (PALS). One of the requirements is to provide support for returning to a home network, and one of the aspects considered in this requirement is as follows (NPL 8):
Study how to mitigate user plane and control plane overload caused by a high number of UEs returning from a temporary local access of a hosting network to their home network in a very short period of time.

### CITATION LIST

### Non Patent Literature

NPL 1: 3GPP TR 21.905: “Vocabulary for 3GPP Specifications”. V17.1.0 (2021-12)
NPL 2: 3GPP TS 23.501: “System architecture for the 5G System (5GS); Stage 2”. V17.4.0 (2022-03)
NPL 3: 3GPP TS 23.502: “Procedures for the 5G System (5GS); Stage 2”. V17.4.0 (2022-03)
NPL 4: 3GPP TS 22.261: “Service requirements for the 5G System; Stage 1”. V18.5.0 (2021-12)
NPL 5: 3GPP TR 22.844: “Study on 5G Network Providing Access to Localized Services; Stage 1”. V18.2.0 (2021-12)
NPL 6: 3GPP TR 23.700-07: “Study on enhanced support of Non-Public Networks (NPN)”. V17.0.0 (2021-03)
NPL 7: 3GPP TS 23.122: “Non-Access-Stratum (NAS) functions related to Mobile Station (MS) in idle mode” V17.6.0 (2022-03)
NPL 8: 3GPP TR 23.700-08: “Study on enhanced support of Non-Public Networks (NPN); Phase 2”. V0.3.0 (2022-05)
NPL 9: 5G-ACIA White Paper: “5G Non-Public Networks for Industrial Scenarios”

### SUMMARY OF INVENTION

### Technical Problem

According to the current specification TS 23.501 (NPL 2), there are two techniques to control the overload at home network: i) access control and barring and ii) control plane load control, congestion and overload control. However, these techniques would lead to overload when a high number of UEs attempt to re-register to their home network simultaneously after accessing a localized service from a temporary hosting network, and they increase the waiting time of UEs as random back-off timer value is assigned to UEs to wait before making another attempt due to overload.

### Solution to Problem

In a first example aspect, a method of an Access and Mobility Management Function (AMF) in a network that provides access to a localized service includes:
performing registration with a plurality of User Equipments (UEs) for the localized service; and
controlling a deregistration of part of the plurality of UEs, in a case where the localized service is ended.

In a second example aspect, a method of a User Equipment (UE) includes:
performing registration with an Access and Mobility Management Function (AMF) in a network that provides access to a localized service to a plurality of UEs that includes the UE; and
performing a deregistration with the AMF, in a case where the localized service is ended,
wherein the deregistration is performed with part of the plurality of UEs.

In a third example aspect, an Access and Mobility Management Function (AMF) in a network that provides access to a localized service includes:
means for performing registration with a plurality of User Equipments (UEs) for the localized service; and
means for controlling a deregistration of part of the plurality of UEs, in a case where the localized service is ended.

In a fourth example aspect, a User Equipment (UE) includes:
means for performing registration with an Access and Mobility Management Function (AMF) in a network that provides access to a localized service to a plurality of UEs that includes the UE; and
means for performing a deregistration with the AMF, in a case where the localized service is ended,
wherein the deregistration is performed with part of the plurality of UEs.

### Advantageous Effects of Invention

According to the present disclosure, it is possible to provide a method for mitigating overload at home network.

### BRIEF DESCRIPTION OF DRAWINGS

FIG. 1 is a signalling diagram of a First Aspect.

FIG. 2 is a signalling diagram of a variant 4 of the First Aspect.

FIG. 3 is a signalling diagram of a Second Aspect.

FIG. 4 is a signalling diagram of a variant 3 of the Second Aspect.

FIG. 5 is a signalling diagram of a Third Aspect.

FIG. 6 is a signalling diagram of a variant 1 of the Third Aspect.

FIG. 7 is a signalling diagram of a Fourth Aspect.

FIG. 8 is a signalling diagram of a variant 1 of the Fourth Aspect.

FIG. 9 is a diagram illustrating a system overview.

FIG. 10 is a block diagram illustrating a UE.

FIG. 11 is a block diagram illustrating an (R) AN node.

FIG. 12 is a diagram illustrating System overview of (R) AN node based on O-RAN architecture.

FIG. 13 is a block diagram illustrating an RU.

FIG. 14 is a block diagram illustrating a DU.

FIG. 15 is a block diagram illustrating a CU.

FIG. 16 is a block diagram illustrating an AMF.

FIG. 17 is a block diagram illustrating an SMF.

FIG. 18 is a block diagram illustrating a UPF.

FIG. 19 is a block diagram illustrating a PCF.

FIG. 20 is a block diagram illustrating an NEF.

FIG. 21 is a block diagram illustrating a UDM.

FIG. 22 is a block diagram illustrating an NWDAF.

### DESCRIPTION OF EMBODIMENTS

### Abbreviations

For the purposes of the present document, the abbreviations given in TR 21.905 (NPL 1) and the following apply. An abbreviation defined in the present document takes precedence over the definition of the same abbreviation, if any, in TR 21.905 (NPL 1).
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
ABBA Anti-Bidding-down Between Architectures
AF Application Function
AMF Access and Mobility Management Function
API Application Programming Interface
AS Access Stratum
ATSSS Access Traffic Steering, Switching, Splitting
ATSSS-LL ATSSS Low-Layer
AUSF Authentication Server Function
AUTN Authentication token
BBF Broadband Forum
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
CU Centralized Unit
DAPS Dual Active Protocol Stacks
DL Downlink
DN Data Network
DNAI DN Access Identifier
DNN Data Network Name
DRX Discontinuous Reception
DS-TT Device-side TSN translator
DU Distributed Unit
ePDG evolved Packet Data Gateway
EAP Extensible Authentication Protocol
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI International Mobile Equipment Identity
IMEI/TAC IMEI Type Allocation Code
IMS IP Multimedia Subsystem
IOWN Innovative Optical and Wireless Network
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
LTE Long Term Evolution
MAC Medium Access Control
MCC Mobile country code
MCX Mission Critical Service
MDBV Maximum Data Burst Volume
MFBR Maximum Flow Bit Rate
MICO Mobile Initiated Connection Only
MNC Mobile Network Code
MO Mobile Originated
MPS Multimedia Priority Service
MPTCP Multi-Path TCP Protocol
MT Mobile Terminated
MT Mobile Termination
N3IWF Non-3GPP InterWorking Function
N5CW Non-5G-Capable over WLAN
NAI Network Access Identifier
NAS Non-Access Stratum
NEF Network Exposure Function
NF Network Function
NGAP Next Generation Application Protocol
ngKSI Next Generation Key Set Identifier
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NW-TT Network-side TSN translator
NWDAF Network Data Analytics Function
O-RAN Open RAN Alliance
O-DU O-RAN Distributed Unit
O-CU O-RAN Centralized Unit
O-RU O-RAN Radio Unit
PCF Policy Control Function
PDB Packet Delay Budget
PDCP Packet Data Convergence Protocol
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
QoS Quality of Service
RACS Radio Capabilities Signalling optimisation
(R) AN (Radio) Access Network
RG Residential Gateway
RU Radio Unit
RIM Remote Interference Management
RLC Radio Link Control
RQA Reflective QoS Attribute
RQI Reflective QoS Indication
RRC Radio Resource Control
RSN Redundancy Sequence Number
SA NR Standalone New Radio
SBA Service Based Architecture
SBI Service Based Interface
SCP Service Communication Proxy
SD Slice Differentiator
SDAP Service Data Adaptation Protocol
SEAF Security Anchor Functionality
SEPP Security Edge Protection Proxy
SMF Session Management Function
SMS Short Message Service
SMSF Short Message Service Function
SN Sequence Number
SN name Serving Network Name.
SNPN Stand-alone Non-Public Network
S-NSSAI Single Network Slice Selection Assistance Information
SOR Steering Of Roaming
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAI Tracking Area Identity
TCP Transmission Control Protocol
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UP User Plane
UPF User Plane Function
URLLC Ultra Reliable Low Latency Communication
URRP-AMF UE Reachability Request Parameter for AMF
URSP UE Route Selection Policy
UU Interface between User Equipment and Radio Access Network
VID VLAN Identifier
VLAN Virtual Local Area Network
W-5GAN Wireline 5G Access Network
W-5GBAN Wireline BBF Access Network
W-5GCAN Wireline 5G Cable Access Network
W-AGF Wireline Access Gateway Function
WLAN Wireless Local Area Network
WUS Wake Up Signal

### Definitions

For the purposes of the present document, the terms and definitions given in 3GPP TR 21.905 (NPL 1) and the following apply. A term defined in the present document takes precedence over the definition of the same term, if any, in 3GPP TR 21.905 (NPL 1).

Home network: A network owning the current in use subscription/credential of the UE. Home network can be either PLMN or NPN.

Home network service: Service, which is offered to UE based on subscription agreed with home network operator.

Hosting network: A network providing access to Local/Localized services.

Local service, Localized service: Service, which is localized (i.e. provided at specific/limited area) and/or can be bounded in time. The service can be realized via applications (e.g. live or on-demand audio/video stream, electric game, IMS, etc), or connectivity (e.g. UE to UE, UE to Data Network, etc.).

Localized service provider: Application provider or network operator who make their services localized and to be offered to end user via a hosting network. Non-Public Network (NPN): A network that is intended for non-public use. Public network integrated NPN: A non-public network deployed with the support of a PLMN.

Return to home network: UE leaves the hosting network (e.g. when the Local/Localized service is terminated), and resumes to use subscription/credential of home network. It can involve a network selection (e.g. select HPLMN or VPLMN) and can involve deactivation/activation of SNPN access mode.

Stand-alone Non-Public Network (SNPN): A non-public network not relying on network functions provided by a PLMN.

### (First Aspect (Solution 1))

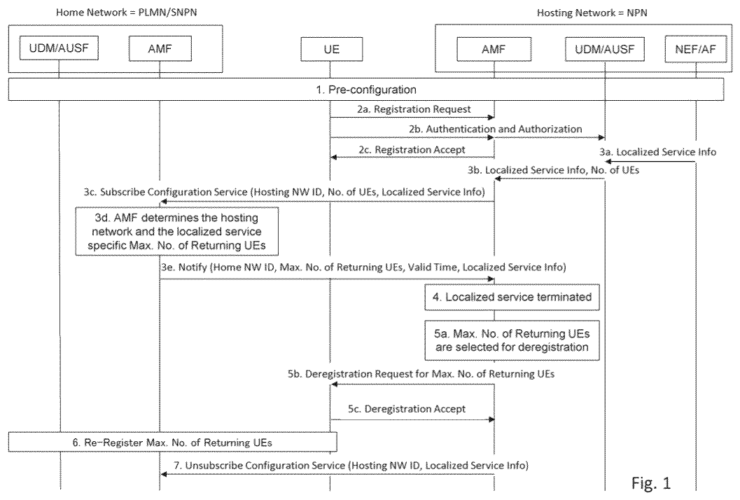

Referring to FIG. 1, this solution solves, or at least mitigates, the problem of overloading at a home network by deregistering UEs from the hosting network in an adaptive manner based on the input from the home network.

One of the first aspects is a method for a first node of Access and Mobility Management in a first network. The first network may be hosting network such as a local network, SNPN or PNI-NPN.

First step of this aspect, the first node of Access and Mobility Management receives, from a second node of Access and Mobility Management included in a second network, a value. The value indicates the number of first UEs allowed to register in the second network per unit time. The number of the first UEs may be allowed maximum number of returning UEs from the first network to the second network per unit time. The second network may be home network such as PLMN or NPN.

Second step of this aspect, the first node transmits, to at least one second UE among third UEs registered to the first network, a first message to de-register from the first network. The first message may be deregistration request message, or UE configuration update command indicating to de-register from the first network. The number of the third UEs is equal to or less than the number of the first UEs.

One of the first aspects may include the followings. The first node sends, to the second node, a subscribe request for allowed maximum number of retuning UEs to the second node. The first node sends, to the second node, unsubscribe to the allowed maximum number of retuning UEs to the second node after the all of the UEs return to the second network. Detailed of this aspect is described below. There are two types of NPNs: Stand-alone NPN (SNPN) and Public Network Integrated NPN (PNI-NPN). Both types of NPNs can be used as hosting networks to access the localized services. The home network can be a PLMN or an SNPN. In this case, the hosting network AMF subscribes to the home network AMF to get a notification of the allowed maximum number of returning UE(s) from the hosting network to the home network per unit time. The allowed maximum number of returning UE(s) from the hosting network to the home network per unit time may be the number of UE(s), the UE(s) returning from the hosting network to the home network per unit time, and the number of UE(s) is allowed by the home network such as the home network AMF. Based on the subscription request, the home network AMF determines a value, the value may be the hosting network and or the localized service specific maximum allowed number of returning UE(s) to the home network per unit time. And based on the subscription request, the home network AMF notifies (or transmits, sends) the hosting network AMF of the hosting network and or the localized service specific maximum allowed number of returning UEs to the home network per unit time. After the localized service is terminated, the hosting network AMF selects UE(s) as the number of selected UEs is equal to or less than the allowed maximum number of returning UEs. And the hosting network AMF deregisters the selected UE(s) simultaneously or during the unit time. Then, the deregistered UE(s) select the home network. And the deregistered UE(s) initiate the registration procedure to attach to the home network. The registration procedure may include that the deregistered UE(s) transmits a registration request message to the home network AMF. If there is a change in the allowed maximum number of returning UE(s) to the home network per unit time from the hosting network, then the home network AMF notifies the new value to the hosting network AMF in a new notification. This process of deregistering UEs from the hosting network in an adaptive manner based on the input from the home network continues until all UEs registered for the localized service are deregistered from the hosting network.

FIG. 1 will now be described in more detail by way of example only. FIG. 1 shows an Adaptive deregistration procedure.

1. There is an agreement between the hosting network and the home network. Based on the agreement, the home and the hosting networks identities, locations, and/or the localized services information are pre-configured for communication purposes.

2a. A UE initiates registration with the hosting network for accessing the localized service. The UE sends Registration Request message to the hosting network AMF. The Registration Request message may include the identity of the home network of UE.

2b. The authentication procedure is performed and the UE is authorized to access the localized service.

Note: The home network credentials of UEs to authenticate and authorize the access to localized services can be used to identify the home network of UEs. If other credentials are used for accessing localized services, then UEs can share their home network ID to the hosting network when initiating the registration procedure for accessing the localized service.

2c. The hosting network AMF accepts the registration of the UE. The hosting network AMF sends Registration Accept message to the UE.

3a. An AF provides the localized service information. If the AF is under the control of 3rd party service providers including other network operators and the localized service providers, then the AF provides the localized service information via an NEF.

3b. When a UDM receives the localized service information, the UDM forwards the localized service information by including the number of UEs registered for the localized service.

3c. The hosting network AMF subscribes to a configuration service for deregistering the hosting network UEs in an adaptive manner. The subscription request includes the hosting network ID, the localized service information, and/or the number of UEs registered for the localized service.

3d. Upon receiving the subscription request from the hosting network AMF, the home network AMF determines the hosting network and/or the localized service specific maximum allowed number of returning UEs to the home network per unit time, which is used for simultaneous/or within the unit time deregistration at the hosting network.

The home network AMF can determine the maximum number of UEs. The maximum number is that the home network AMF can handle at a time based on the home network AMF's processing capacity.

Based on the given number of UEs registered for the localized service in the hosting network, the localized service end time, and/or the number of UEs that can attempt to register from the home network and other hosting networks, the home network AMF determines the hosting network and/or the localized service specific maximum allowed number of returning UEs per unit time to the home network. The home network AMF ensures that the total number of UEs attempting to register at a time from the home network and hosting networks do not exceed the maximum number of UEs. The total number of UEs attempting to register at the time is so that the home network AMF can handle based on its processing capability in order to avoid congestion and overloading.

3e. The home network AMF notifies the hosting network of the number of maximum allowed returning UEs to the home network per unit time. The notification includes the hosting network ID, the allowed maximum number of returning UEs for deregistration per unit time, valid time to follow this instruction, and/or the localized service information that UEs are accessing. The valid time to follow this instruction is how many unit times the notified value of the allowed maximum number of returning UEs is applicable for deregistration of UEs in the hosting network within the unit time. For example, if the valid time to follow this instruction is 2, the notified value of the allowed maximum number of returning UEs is valid as the allowed maximum number of returning UEs for each unit time in 2-unit times.

If there is a change in the allowed maximum number of returning UEs from the hosting network to the home network per unit time due to an increase or a decrease in the number of UEs that can attempt to register from the home network and other hosting networks, then the home network AMF notifies the new value (the updated allowed maximum number of returning UEs) to the hosting network AMF in a new notification. In this case, the hosting network AMF follows the instruction in the new notification and discards the old notification, i.e. the new notification always has higher precedence than the old notification.

4. The temporary localized service is over or terminated at the hosting network.

5a. The hosting network AMF selects the number of returning UEs from the list of registered UEs for the localized service. The selection is for simultaneous or within the unit time deregistration of UEs in an adaptive manner, based on the notification from the home network AMF, and ensures that the number of returning UEs from the hosting network does not exceed the maximum number of UEs the home network AMF can handle. Or the selected number of returning UEs is equal to or less than the notified value of the allowed maximum number of returning UEs.

Note: The notified value of the allowed maximum number of returning UEs to the home network is valid until the valid time is expired.

5b. The hosting network AMF initiates the simultaneous or within the unit time deregistration of UEs for the selected number of returning UEs to the home network.

Note: Some UEs may initiate deregistration procedure before the localized service is terminated. The hosting network AMF can handle UE-initiated deregistration requests as well. In order to allow the hosting network AMF to select the number of returning UEs to the home network, the service termination time of UEs can be set to slightly higher than the actual localized service termination time.

5c. The UEs deregister from the hosting network and the AMF accepts the deregistration. This step may be that the UEs send deregistration accept message to the hosting network AMF.

Note: After deregistration, the UEs place the hosting network NPN in a temporary forbidden list and initiate automatic PLMN/SNPN network selection mode.

6. Deregistered UEs leave the hosting network and initiate (re-) registration to their home network.

7. Once all UEs registered for the localized service are deregistered from the hosting network, the hosting network AMF unsubscribes from the configuration service. The request to unsubscribe from the configuration service for a temporary localized service includes the hosting network ID and the localized service information.

According to this aspect, since the hosting network is provided with upper limit (the allowed maximum number of returning UEs from the hosting network to the home network) per unit time, the number of de-registered UEs performing (re-) registration to the home network can be limited so as not to exceed the upper limit per unit time. Therefore, the load on the home network can be reduced.

### (Variant 1 of the First Aspect)

In step 3a, the AMF may have subscribed to the UDM service after the successful registration procedure in steps 2a, 2b and 2c in order to receive the Localized Service info from the UDM.

In this case, the AMF sends the Nudm_EventExposure_Subscribe message to the UDM with the application ID that the AMF would like to be notified. Upon the UDM receives the Nudm_EventExposure_Subscribe message from the AMF, then the UDM sends the Nnef_EventExposure_Subscribe message to either the NEF or the AF including the received Application ID from the AMF. With this subscription to the NEF or the AF, the NEF or the AF notifies a Localized Service Info by sending an Nnef_EventExposure_Notify message to the UDM in step 3a. Upon the UDM receives the Nnef_EventExposure_Notify message including the Localized Service Info from the NEF or the AF, the UDM sends the Nudm_EventExposure_Notify message including the Localized Service Info to the AMF in step 3b.

### (Variant 2 of the First Aspect)

In step 3a, the AMF may have subscribed to the NEF or the AF service after the successful registration procedure in steps 2a, 2b and 2c in order to receives the Localized Service info from the NEF or the AF directly without involving the UDM.

In this case, the AMF sends the Nnef_EventExposure_Subscribe message to the NEF or the AF with the application ID that the AMF would like to be notified. With this subscription to the NEF or the AF, the NEF or the AF notifies a Localized Service Info to the AMF by sending the Nnef_EventExposure_Notify message to the AMF directly.

### (Variant 3 of the First Aspect)

In step 4, the AMF recognizes that the Localized service has been terminated by an explicit signalling for the AF.

If the AMF subscribes to the UDM service as described in the Variant 1 of the First Aspect, then the AMF receives the Nudm_EventExposure_Notify message from the UDM including a Localized Service Information that indicates a service termination. The UDM sends the Nudm_EventExposure_Notify message to the AMF when the UDM receives the Nnef_EventExposure_Notify message from the NEF or the AF.

If the AMF subscribes to the NEF or the AF service as described in the Variant 2 of the First Aspect, then the AMF receives the Nnef_EventExposure_Notify message from the NEF or the AF including a Localized Service Information that indicates a service termination.

### (Variant 4 of the First Aspect)

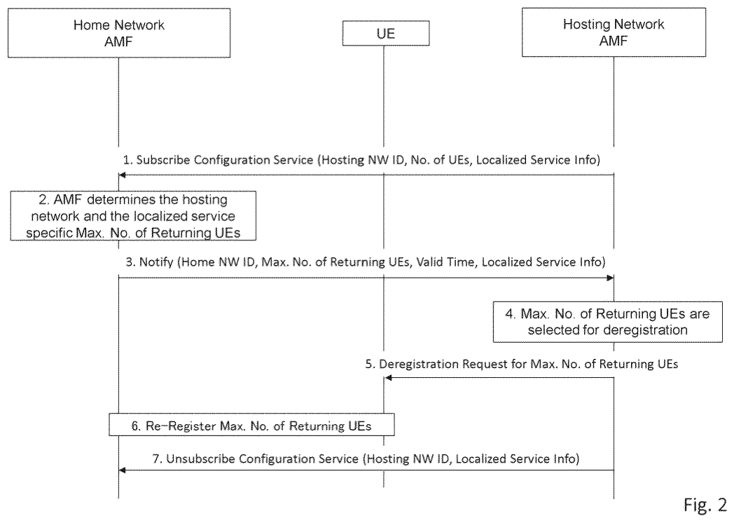

FIG. 2 shows an Adaptive deregistration procedure of variant 4 of the first aspect.

1. The hosting network AMF subscribes to a configuration service for deregistering the hosting network UEs. The subscription request includes the hosting network ID, the localized service information, and/or the number of UEs registered for the localized service.

2. Upon receiving the subscription request from the hosting network AMF, the home network AMF determines the hosting network and/or the localized service specific maximum allowed number of UEs that can be returned from the hosting network to the home network per unit time, which is used for simultaneous/or within the unit time deregistration at the hosting network.

3. The home network AMF notifies the hosting network of the number of maximum allowed returning UEs to the home network per unit time. The notification includes the hosting network ID, the allowed maximum number of returning UEs for deregistration per unit time, valid time to follow this instruction, and/or the localized service information that UEs are accessing. The valid time to follow this instruction is how many unit times the notified value of the allowed maximum number of returning UEs is applicable for deregistration of UEs in the hosting network within the unit time.

4. The hosting network AMF selects the number of returning UEs from the list of registered UEs for the localized service. The selection is for simultaneous or within the unit time deregistration of UEs in an adaptive manner, based on the notification from the home network AMF, and ensures that the number of returning UEs from the hosting network does not exceed the maximum number of UEs the home network AMF can handle. Or the selected number of returning UEs is equal to or less than the notified value of the allowed maximum number of returning UEs.

5. The hosting network AMF initiates deregistration of UEs for the selected number of returning UEs to the home network simultaneously or within the unit time.

6. Deregistered UEs leave the hosting network and initiate (re-) registration to their home network. Up to the number of maximum allowed returning UEs can be initiate the registration procedure to the home network.

7. The hosting network AMF unsubscribes the configuration service after all UEs who subscribed for the localized service are deregistered. The request to unsubscribe from the configuration service for a temporary localized service includes the hosting network ID and the localized service information.

### (Second Aspect (Solution 2))

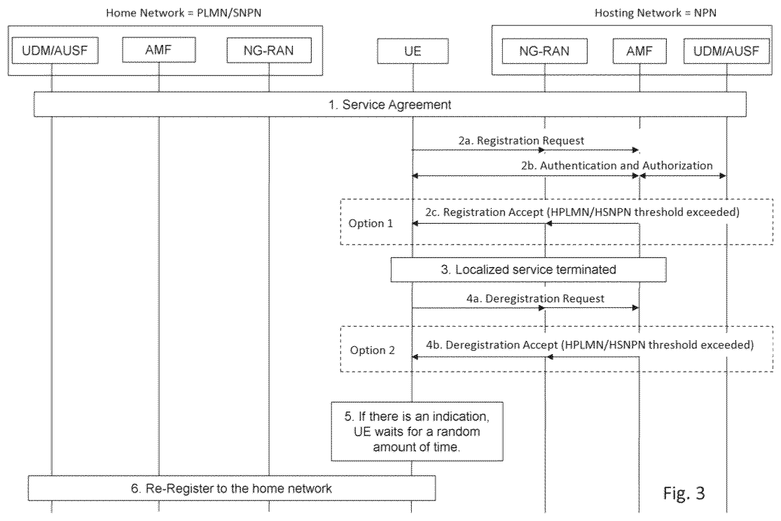

Referring to FIG. 3, this solution solves, or at least mitigates, the problem of overloading at home network by making UEs wait for a random amount of time before initiating the re-registration procedure to their home network if the number of returning UEs to the home network exceeds the given threshold value.

One of the second aspects is a method for a first node of Access and Mobility Management in a first network. The first network may be hosting network such as a local network, SNPN or PNI-NPN.

First step of this aspect, the first node of Access and Mobility Management receives, from a second node of Access and Mobility Management included in a second network, a value. The value indicates the number of first UEs allowed to register the second network per unit time. The number of the first UEs may be allowed maximum number of returning UEs from the first network to the second network per unit time. The second network may be home network such as PLMN or NPN.

Second step of this aspect, the first node transmits, to at least one second UE among third UEs registered to the first network, a first message to de-register from the first network within the unit time. The first message may be deregistration request message, or UE configuration update command indicating to de-register from the first network. The number of the third UEs is equal to or less than the number of the first UEs.

Third step of this aspect, the first node transmits, to at least one forth UE among fifth UEs registered to the first network, a second message to de-register from the first network. The second message includes a first indication. The first indication indicates a waiting time for the UE waiting to transmit registration request message to the second node. The first indication may indicate the UE need to wait before transmitting the registration request message. The waiting time is equal to or more than the unit time. The fifth UEs do not overlap to the third UEs. The waiting time may be random amount of time. The random amount of time may be calculated by the UE, by the first node, or by the second node.

The waiting time may be different for each of the fifth UEs.

Detailed of this aspect is described below. There is an agreement between the home network and the hosting network. Based on the agreement, the home network provides the allowed maximum number of UEs which can be returned from the hosting network per unit time. This allowed maximum number of the UEs (it may be maximum threshold value) may be provided to the hosting network as part of the service agreement or via over the air interaction with the home network. When the number of UEs registered to the hosting network for accessing the localized service exceeds the allowed maximum number of the UEs given by the home network, the hosting network AMF indicates a new parameter as ‘HPLMN/HSNPN threshold exceeded’ either in a Registration Accept message or in a Deregistration Accept message. After deregistering from the hosting network, UEs wait for a time if there is an indication. Otherwise, UEs initiate the registration procedure to their home network immediately after leaving the hosting network. The time may be a random amount of time. The time may be indicated by the indication. The random amount of time may be calculated by the UE, by the hosting network AMF, or by the home network AMF. The time may be different for each UEs.

FIG. 3 will now be described in more detail by way of example only. FIG. 3 shows a Randomized re-registration procedure.

1. There is a service agreement between the home network and the hosting network. Based on the agreement, the home network provides the allowed maximum number of UEs which can be returned from the hosting network per unit time. This allowed maximum number of UEs (may be a maximum threshold value) may be provided to the hosting network as part of the service agreement or via over the air interaction with the home network.

2a. A UE initiates registration with the hosting network for accessing the localized service. It may be the UE sends a registration request message to the hosting network.

2b. The authentication procedure is performed and the UE is authorized to access the localized service.

Note: The home network credentials of UEs to authenticate and authorize the access to localized services can be used to identify the home network of UEs. If other credentials are used for accessing localized services, then UEs can share their home network ID to the hosting network when initiate the registration procedure for accessing the localized service.

2c. The hosting network AMF accepts the registration of the UE. It may be the hosting network AMF sends a registration accept message to the UE.

If the number of UEs registered for accessing the localized service in the hosting network exceeds the maximum threshold value given by the home network, then the hosting network AMF includes an indication in the Registration Accept message. This is one option for indicating to UE that the HPLMN/HSNPN threshold exceeded. The indication may indicate the UE need to wait before transmitting the registration request message to the home network AMF. The indication may indicate a time value for which the UE needs to wait before transmitting the registration request message to the home network AMF.

3. The localized service is over or terminated.

4a. After the localized service is terminated, the UE initiates the deregistration procedure. This step may be the hosting network AMF sends a de-registration request message to the UE, or the UE sends the de-registration request message to the hosting network AMF.

Note: The UE may initiate the deregistration procedure before the localized service is terminated and the hosting network AMF can handle it.

4b. The hosting network AMF accepts the deregistration of the UE. This step may be the hosting network AMF sends de-registration accept message to the UE, or the UE sends the de-registration accept message to the hosting network AMF.

If the number of UEs registered for accessing the localized service in the hosting network exceeds the maximum threshold value given by the home network, then the hosting network AMF includes an indication in the Deregistration Accept message from the hosting network AMF to the UE. This is another option for indicating to UE that the threshold exceeded.

Note: After deregistration, UEs place the hosting network NPN in a temporary forbidden list and initiate automatic PLMN/SNPN network selection mode.

5. If there is an indication that the HPLMN/HSNPN threshold has been exceeded either in the Registration Accept message or the Deregistration Accept message, the UE waits for some time before initiating the registration procedure to their home network. The time may be indicated by the indication. The time may be a random amount of time. The time may be different for each UEs. The time may be calculated by the UE using a UE's identifier in order to randomize deferred time among UEs. The UE's identifier may be an IMSI, SUPI, IMEI, GPSI or PEI. The UE's identifier may be a subset (or subfield or predefined bit-length) of IMSI, SUPI, IMEI, GPSI or PEI.

6. The UE (re-) registers to their home network after the timer as described in step 5 expires.

According to this aspect, since the UEs are indicated to wait for some time before initiating the registration procedure to home network if the home network given threshold value exceeds, the timing of the UE's registration procedure is distributed. Therefore, the load on the home network can be reduced.

### (Variant 1 of the Second Aspect)

In step 3, the AMF recognizes that the Localized service has been terminated by an explicit signalling for the AF.

If the AMF subscribes to the UDM service as described in the Variant 1 of the First Aspect, then the AMF receives the Nudm_EventExposure_Notify message from the UDM including a Localized Service Information that indicates a service termination. The UDM sends the Nudm_EventExposure_Notify message to the AMF when the UDM receives the Nnef_EventExposure_Notify message from the NEF or the AF.

If the AMF subscribes to the NEF or the AF service as described in the Variant 2 of the First Aspect, then the AMF receives the Nnef_EventExposure_Notify message from the NEF or the AF including a Localized Service Information that indicates a service termination.

### (Variant 2 of the Second Aspect)

In case where the Network-initiated Deregistration procedure as described in section 4.2.2.3.3 in TS 23.502 (NPL 3) takes place instead of the steps 4a and 4b and if the number of UEs registered for accessing the localized service in the hosting network exceeds the maximum threshold value given by the home network, then the hosting network AMF includes an indication in the Deregistration Request message from the hosting network AMF to the UE. This is another option for indicating to UE that the threshold exceeded.

### (Variant 3 of the Second Aspect)

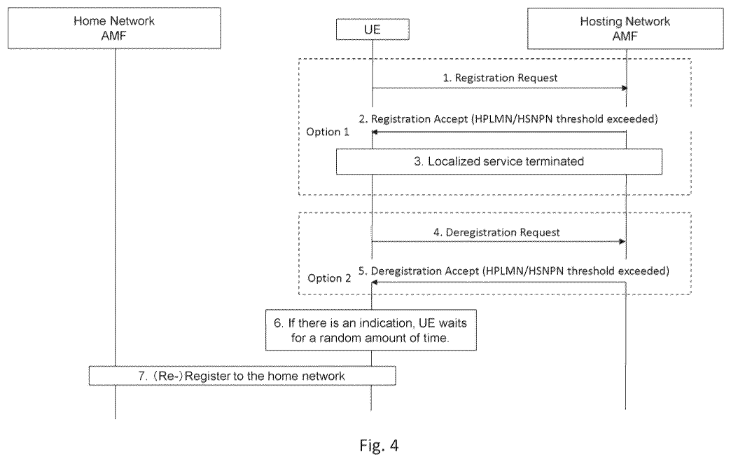

FIG. 4 shows a Randomized registration procedure of variant 3 of the second aspect.

(Option1) 1. A UE initiates registration with the hosting network for accessing the localized service. It may be the UE sends a registration request message to the hosting network.

(Option1) 2. The hosting network AMF accepts the registration of the UE. It may be the hosting network AMF sends a registration accept message to the UE. If the number of UEs registered for accessing the localized service in the hosting network exceeds the maximum threshold value given by the home network, then the hosting network AMF includes an indication in the Registration Accept message. This is one option for indicating to UE that the HPLMN/HSNPN threshold exceeded. The indication may indicate the UE need to wait before transmitting the registration request message to the home network AMF. The indication may indicate a time value for which the UE needs to wait before transmitting the registration request message to the home network AMF.

(Option1) 3. The localized service is over or terminated.

(Option2) 4. The UE initiates the deregistration procedure. The UE sends the de-registration request message to the hosting network AMF.

(Option2) 5. The hosting network AMF accepts the deregistration of the UE. The hosting network AMF sends de-registration accept message to the UE. If the number of UEs registered for accessing the localized service in the hosting network exceeds the maximum threshold value given by the home network, then the hosting network AMF includes an indication in the Deregistration Accept message from the hosting network AMF to the UE.

6. If there is an indication that the HPLMN/HSNPN threshold has been exceeded either in the Registration Accept message or the Deregistration Accept message, the UE waits for some time before initiating the registration procedure to their home network. The time may be indicated by the indication. The time may be a random amount of time. The time may be different for each UEs. The time may be calculated by the UE using a UE's identifier in order to randomize deferred time among UEs. The UE's identifier may be an IMSI, SUPI, IMEI, GPSI or PEI. The UE's identifier may be a subset (or subfield or predefined bit-length) of IMSI, SUPI, IMEI, GPSI or PEI.

7. The UE (re-) registers to their home network after the timer as described in step 5 expires.

### (Third Aspect (Solution 3))

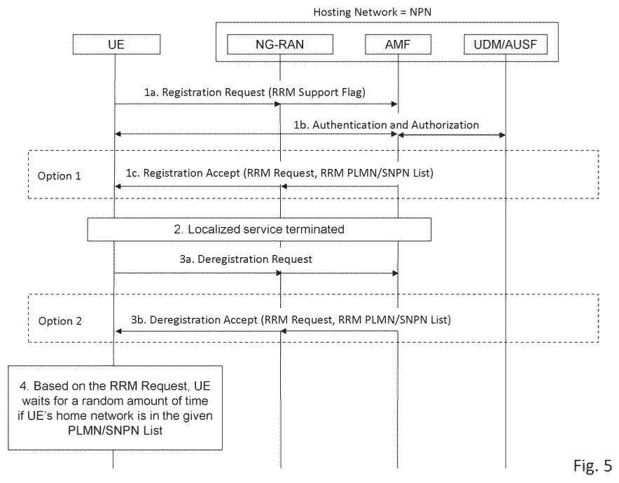

Referring to FIG. 5, this solution solves, or at least mitigates, the problem of overloading at a home network by using a UE supported RRM feature which enables the hosting network to dictate UEs for initiating the registration procedure to their home network after waiting a random amount of time.

One of the third aspects is a method for a first node of Access and Mobility Management in a first network. The first network may be hosting network such as a local network, SNPN or PNI-NPN.

First step of this aspect, the first node receives, from a User Equipment (UE), a first message including a first indication. The first indication indicates that waiting a time to transmit registration request message to a node of Access and Mobility Management in a network is supported at the UE.

Second step of this aspect, the first node transmits, to the UE, a second message. The second message indicates the UE wait time before transmitting the registration request message to a second node of Access and Mobility Management in a second network. The time may be a predetermined time. The time may be a random amount of time. The time may be indicated by the hosting network AMF, or by the home network AMF. The time may be calculated by the UE.

One of the third aspects may include the followings. The second message includes a list. The list indicates identifier (ID) of a Public Land Mobile Network Number (PLMN). And the list indicates whether or not the waiting the predetermined time before transmitting the registration request message to each PLMN.

Detailed of this aspect is described below. When UE(s) initiates the registration procedure in the hosting network, the UE(s) indicate the UE's support of a feature in the Registration Request message. The feature may indicate the UEs can wait for time before initiating the registration procedure to their home network. And the feature may be Randomized Registration Management (RRM) feature. The UE supported RRM feature enables the hosting network AMF to dictate UEs to wait for time before initiating the registration procedure to their home network.

The Registration Accept message or the Deregistration Accept message from the hosting network AMF to the UE(s) may request the UE to wait a time before initiating the registration procedure to their home network. The time may be a predetermined time. The time may be a random amount of time. The time may be indicated by the hosting network AMF, or by the home network AMF. The time may be calculated by the UE. Either in the Registration Accept message or in the Deregistration Accept message, the hosting network AMF may include an RRM Request and PLMN/SNPN List. RRM Request may be a request that the UE to wait a time before initiating the registration procedure to each PLMN. Or the RRM Request may be a request that the UE to wait a time before initiating the registration procedure to a PLMN/SNPN listed in the PLMN/SNPN List. If a UE attempts to register to one of the PLMNs/SNPNs in the list, the RRM Request indicates that the UE is to wait for time before attempting to register to their home network.

FIG. 5 will now be described in more detail by way of example only. FIG. 5 shows a procedure for randomized Registration Management with RRM support.

1a. The UE supported Randomized Registration Management (RRM) feature is indicated in a Registration Request message to the hosting network.

1b. The authentication procedure is performed and the UE is authorized to access the localized service.

Note: The home network credentials of UEs to authenticate and authorize the access to localized services can be used to identify the home network PLMN/SNPN of UEs. If other credentials are used for accessing localized services, then UEs can share their home network PLMN/SNPN ID to the hosting network when initiating the registration procedure for accessing the localized service.

1c. The hosting network AMF accepts the registration of the UE.

As the RRM feature is supported in the UE, the hosting network AMF includes the RRM Request and RRM PLMN/SNPN List in the Registration Accept message to the UE. This is one option for indicating to the UE that the UE is to wait before initiating registration procedure to home network.

2. The localized service is over or terminated.

3a. After the localized service is over, the UE initiates the deregistration procedure in the hosting network. This step may be the UE sends de-registration request message to the hosting network AMF. Or this step may be the hosting network AMF sends de-registration request message to the UE. As the RRM feature is supported in UE, the hosting network AMF includes the RRM Request and RRM PLMN/SNPN List in the Deregistration Request message to the UE. This is another option for indicating to the UE that the UE is to wait.

3b. The hosting network AMF accepts the deregistration of the UE. This step may be the hosting network AMF sends a Deregistration Accept message to the UE. Or this step may be the UE sends Deregistration Accept message to the hosting network AMF.

As the RRM feature is supported in UE, the hosting network AMF includes the RRM Request and RRM PLMN/SNPN List in the Deregistration Accept message to UE. This is another option for indicating to the UE that the UE is to wait.

Note: After deregistration, UEs place the hosting network NPN in a temporary forbidden list and initiate automatic PLMN/SNPN network selection mode.

4. Based on the RRM Request, the UE waits for time if the UE's home network is in the given RRM PLMN/SNPN List before initiating the (re-) registration procedure in the home network.

According to this aspect, the registration procedure to home network is made according to the UE's feature. Therefore, it will be possible to reduce the load on the home network while considering the feature of each UEs.

### (Variant 1 of the Third Aspect)

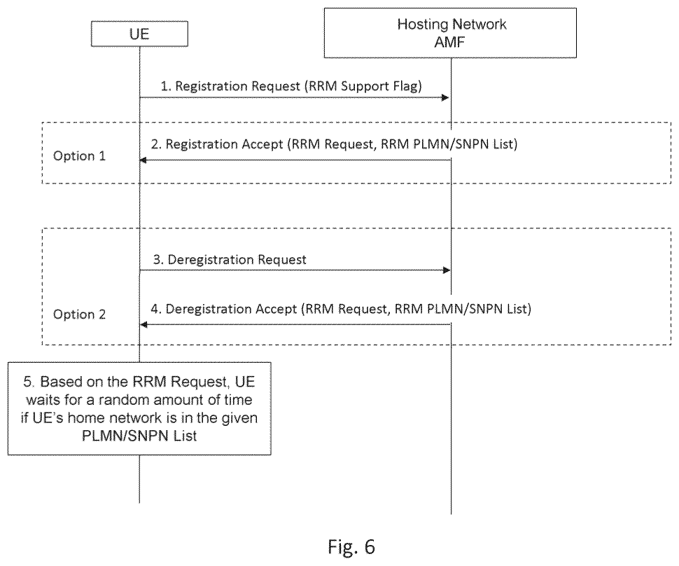

FIG. 6 shows a procedure for Registration Management with RRM support of variant 1 of the Third Aspect.

1. The UE supported Randomized Registration Management (RRM) feature is indicated in a Registration Request message to the hosting network.

(Option1) 2. The hosting network AMF accepts the registration of the UE. As the RRM feature is supported in the UE, the hosting network AMF includes the RRM Request and RRM PLMN/SNPN List in the Registration Accept message to the UE. This is one option for indicating to the UE that the UE is to wait before initiating registration procedure to home network.

(Option2) 3. The UE initiates the deregistration procedure in the hosting network. The UE sends de-registration request message to the hosting network AMF. As the RRM feature is supported in UE, the hosting network AMF includes the RRM Request and RRM PLMN/SNPN List in the Deregistration Request message to the UE.

(Option2) 4. The hosting network AMF accepts the deregistration of the UE. The hosting network AMF sends a Deregistration Accept message to the UE. As the RRM feature is supported in UE, the hosting network AMF includes the RRM Request and RRM PLMN/SNPN List in the Deregistration Accept message to UE. This is another option for indicating to the UE that the UE is to wait.

5. Based on the RRM Request, the UE waits for time if the UE's home network is in the given RRM PLMN/SNPN List before initiating the (re-) registration procedure in the home network.

### (Fourth Aspect (Solution 4))

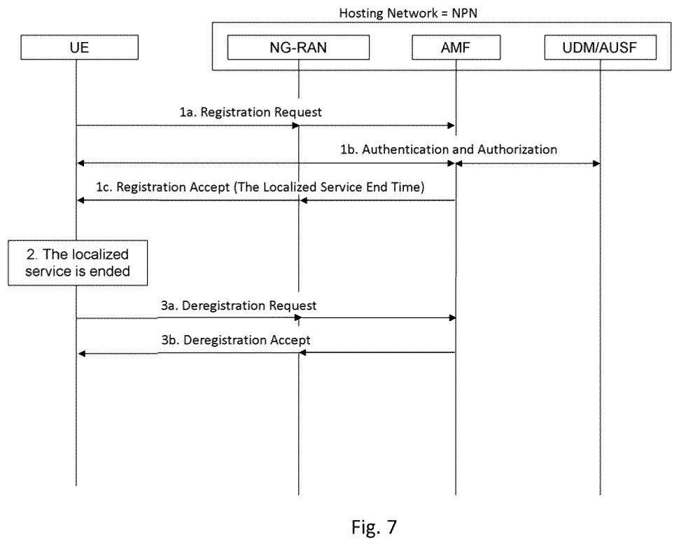

Referring to FIG. 7, this solution solves the problem of overloading at a home network by altering the localized service end time for UEs when registering to the hosting network.

One of the fourth aspects is a method for a first node of Access and Mobility Management in a first network. The first network may be hosting network such as a local network, SNPN or PNI-NPN.

First step of this aspect, the first node receives, from a UE, a registration request message for use a service of the first network, the UE may attempt to temporarily register to the first network to temporarily use the service.

Second step of this aspect, the first node calculates a modified (updated) service end time based on information of the UE and a service end time of the service. The information of the UE is independent for each UEs. The modified service end time may be calculated by adding/subtracting/multiplying/dividing the information of the UE and the service end time of the service. The modified service end time may be calculated by subtracting/dividing the information of the UE and the information of the UE. The modified service end time may be calculated by adding/subtracting/multiplying/dividing value based on the information of the UE and the service end time of the service. The modified service end time may be calculated by subtracting/dividing the service end time of the service and value based on the information of the UE.

Third step of this aspect, the first node transmits, to the UE, a de-registration message based on the modified (updated) service end time. The de-registration message may be transmitted after the modified service end time.

One of the fourth aspects may include the followings. The first node calculates a first modified (updated) service end time based on first information of a first UE and a first service end time of the service for the first UE. The first node calculates a second modified (updated) service end time based on second information of a second UE and a second service end time of the service for the second UE. The first node transmits, to the first UE, a first de-registration message based on the first modified (updated) service end time. The first node transmits, to the second UE, a second de-registration message based on the second modified (updated) service end time. The first modified (updated) service end time and the second modified (updated) service end time are different.

Detailed of this aspect is described below. When UEs register to the hosting network for accessing the localized service, the localized service end time for each UE is slightly altered such that all UEs will not deregister from the hosting network simultaneously (e.g. the service end time at the UE=the actual localized service end time+ (−, *, and/or /) random value). Once the hosting network AMF assigned service end time is over at the UE side, the UE initiates the deregistration procedure. Since the service end time for UEs differ due to the additionally added random value, all UEs will not deregister from the hosting network simultaneously. Thus, all UEs will not attempt to register to their home network at the same time.

FIG. 7 shows a procedure for assigning randomized service end time.

1a. A UE initiates registration with the hosting network for accessing the localized service.

1b. The authentication procedure is performed and the UE is authorized to access the localized service.

1c. The hosting network AMF accepts the registration of the UE and shares the localized service end time to the UE (e.g. service end time at the UE=the actual localized service end time+ (−, *, and/or/) random value). The random value may be different for each UEs. The random value may be based on information of the

UE. The random value may be based on the ID of the UE. The random value may be value of the ID of the UE.

2. The assigned localized service end time is over at the UE.

3a. After the localized service is over, the UE initiates the deregistration procedure in the hosting network.

3b. The hosting network AMF accepts the deregistration of UE.

Note: After deregistration, the UEs put the hosting network NPN in a temporary forbidden list and initiate automatic PLMN/SNPN network selection mode.

### (Variant 1 of the Fourth Aspect)

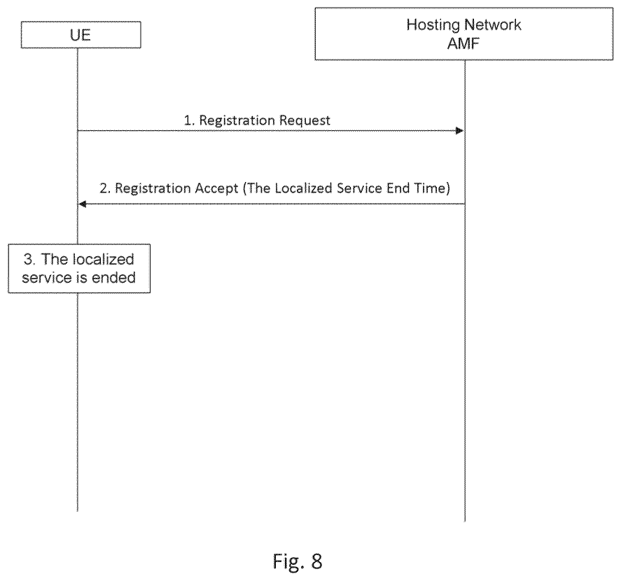

FIG. 8 shows a procedure for assigning randomized service end time of variant 1 of the Fourth Aspect.

1. A UE initiates registration with the hosting network for accessing the localized service.

2. The hosting network AMF accepts the registration of the UE and shares the localized service end time to the UE (e.g. service end time at the UE=the actual localized service end time+ (−, *, and/or/) random value). The random value may be different for each UEs. The random value may be based on information of the

UE. The random value may be based on the ID of the UE. The random value may be value of the ID of the UE. The UE's identifier may be an IMSI, SUPI, IMEI, GPSI or PEI. The UE's identifier may be a subset (or subfield or predefined bit-length) of IMSI, SUPI, IMEI, GPSI or PEI.

3. The assigned localized service end time is over at the UE.

(System overview)

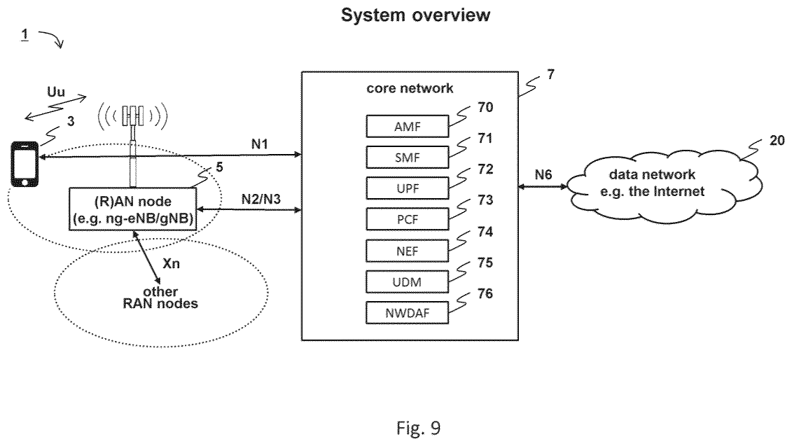

FIG. 9 schematically illustrates a telecommunication system 1 for a mobile (cellular or wireless) device (known as a user equipment (UE)) to which the above aspects are applicable.

The telecommunication system 1 represents a system overview in which an end-to-end communication is possible. For example, the UE 3 (or user equipment, ‘mobile device’ 3) communicates with other UEs 3 or service servers in the data network 20 via respective (R) AN nodes 5 and a core network 7.

The (R) AN node 5 supports any suitable radio access technology including, for example, a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R) AN node 5 may split into a Radio Unit (RU), Distributed Unit (DU) and Centralized Unit (CU). In some aspects, each of the units may be connected to each other and structure the (R) AN node 5 by adopting an architecture as defined by the Open RAN (O-RAN) Alliance, where the units above are referred to as O-RU, O-DU and O-CU respectively.

The (R) AN node 5 may be split into one or more control plane functions and one or more user plane functions. Further, multiple user plane functions can be allocated to support a communication. In some aspects, user traffic may be distributed to multiple user plane functions and user traffic over each user plane function is aggregated in both the UE 3 and the (R) AN node 5. This split architecture may be called ‘dual connectivity’ or ‘Multi connectivity’.

The (R) AN node 5 can also support a communication using the satellite access. In some aspects, the (R) AN node 5 may support a satellite access and a terrestrial access.

In addition, the (R) AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R) AN node 5 as the UE 3 is moving around in the geographical area covered by the telecommunication system 1. In order to keep track of the UE 3 and to facilitate movement between the different (R) AN nodes 5, the core network 7 comprises at least one access and mobility management function (AMF) 70. The AMF 70 is in communication with the (R) AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public

Land Mobile Network (HPLMN) of the UE 3 provides the UDM 75 and at least some of the functionalities of the SMF 71, UPF 72, and PCF 73 for the roaming-out UE 3.

The UE 3 and a respective serving (R) AN node 5 are connected via an appropriate air interface (for example the so-called “Uu” interface and/or the like). Neighboring (R) AN nodes 5 are connected to each other via an appropriate (R) AN node 5 to (R) AN node interface (such as the so-called “Xn” interface and/or the like). Each (R) AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network, or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPV6, IPv4v6, Ethernet or unstructured data type.

The “Uu” interface may include a Control plane and User plane.

The User plane of the Uu interface is responsible for conveying user traffic between the UE 3 and a serving (R) AN node 5. The User plane of the Uu interface may have a layered structure with SDAP, PDCP, RLC and MAC sublayer over the physical connection.

The Control plane of the Uu interface is responsible for establishing, modifying, and releasing a connection between the UE 3 and a serving (R) AN node 5. The Control plane of the Uu interface may have a layered structure with RRC, PDCP, RLC and MAC sublayers over the physical connection.

For example, the following messages are communicated over the RRC layer to support AS signalling.
RRC Setup Request message: This message is sent from the UE 3 to the (R) AN node 5. In addition to the parameters that are disclosed by Aspects in this disclosure, any of the following parameters may be included together in the RRC Setup Request message.
#establishmentCause and ue-Identity. The ue-Identity may have a value of ng-5G-S-TMSI-Part1 or randomValue.
RRC Setup message: This message is sent from the (R) AN node 5 to the UE 3. In addition to the parameters that are disclosed by Aspects in this disclosure, any of the following parameters may be included together in the RRC Setup message. #masterCellGroup and radioBearerConfig
RRC Setup Complete message: This message is sent from the UE 3 to the (R) AN node 5. In addition to the parameters that are disclosed by Aspects in this disclosure, any of the following parameters may be included together in the RRC Setup Complete message.
#guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible for providing a communication between the UE 3 and the AMF 70 to support NAS signalling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by Aspects in this disclosure, any of the following parameters may be included together in the Registration Request message.
#5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by Aspects in this disclosure, any of the following parameters may be included together in the Registration Accept message.
#5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, the following parameter may be included together in the Registration Complete message.
#SOR transparent container.
Authentication Request message: This message is sent from the AMF 70 to the UE 3. In addition to the parameters that are disclosed by Aspects in this disclosure, any of the following parameters may be included together in the Authentication Request message.
#ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, any of the following parameters may be populated together in the Authentication Response message.
#Authentication response message identity, Authentication response parameter and EAP message.
Authentication Result message: This message is sent from the AMF 70 to the UE 3. In addition to the parameters that are disclosed by Aspects in this disclosure, any of the following parameters may be populated together in the Authentication Result message.
#ngKSI, EAP message and ABBA.
Authentication Failure message: This message is sent from the UE 3 to the AMF 70. In addition to the parameters that are disclosed by Aspects in this disclosure, any of the following parameters may be populated together in the Authentication Failure message.
#Authentication failure message identity, 5GMM cause and Authentication failure parameter.
Authentication Reject message: This message is sent from the AMF 70 to the UE 3. In addition to the parameters that are disclosed by Aspects in this disclosure, the following parameter may be populated together in the Authentication Reject message.
#EAP message.
Service Request message: This message is sent from the UE 3 to the AMF 70. In addition to the parameters that are disclosed by Aspects in this disclosure, any of the following parameters may be populated together in the Service Request message.
#ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, any of the following parameters may be populated together in the Service Accept message.
#PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, any of the following parameters may be populated together in the Service Reject message.
#5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, any of the following parameters may be populated together in the Configuration Update Command message.
#Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, the following parameter may be populated together in the Configuration Update Complete message.
#Configuration update complete message identity.

### User Equipment (UE)

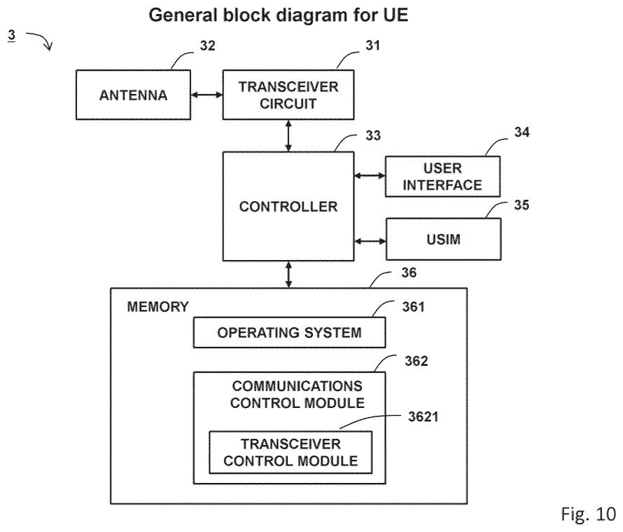

FIG. 10 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the FIG. 10, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (e.g. a removable memory device (RMD)), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R) AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### (R)AN Node

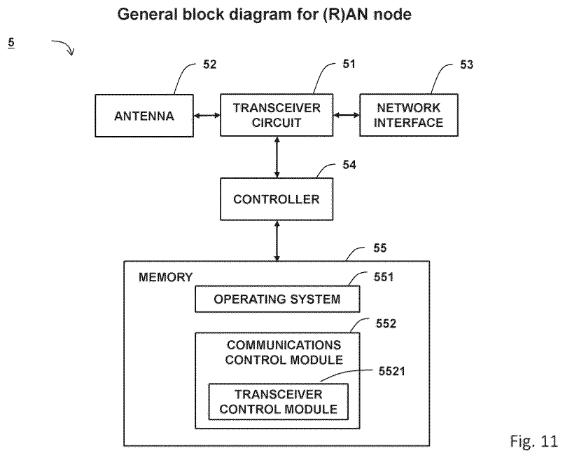

FIG. 11 is a block diagram illustrating the main components of an exemplary (R) AN node 5, for example a base station (′eNB′ in LTE, ‘gNB’ in 5G, a base station for 5G beyond, a base station for 6G). As shown, the (R) AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R) AN node 5 in accordance with software stored in a memory 55. Software may be pre-installed in the memory and/or may be downloaded via the telecommunication network or from a removable data storage device (e.g. an RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R) AN node 5 and other nodes, such as the UE 3, another (R) AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R) AN node 5 may support the Non-Public Network (NPN), The NPN may be a Stand-alone Non-Public Network (SNPN) or a Public Network Integrated NPN (PNI-NPN).

### System Overview of (R) AN Node 5 Based on O-RAN Architecture

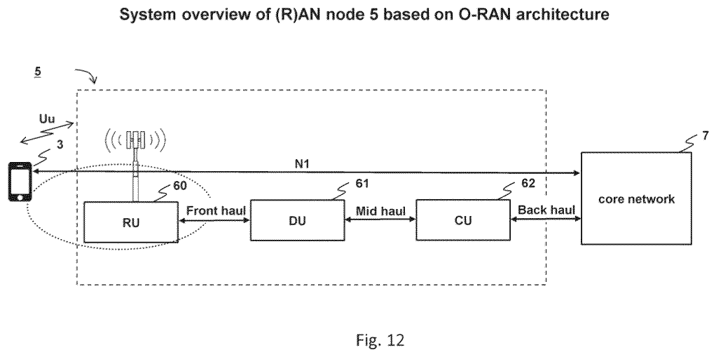

FIG. 12 schematically illustrates a (R) AN node 5 based on O-RAN architecture to which the (R) AN node 5 aspects are applicable.

The (R) AN node 5 based on O-RAN architecture represents a system overview in which the (R) AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R) AN node 5. The CU UP has a user plane functionality in the (R) AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R) AN node 5. For example, the RU 60 may provide a functionality to communicate with a UE 3 over air interface, the DU 61 may provide functionalities to support MAC layer and RLC layer, the CU 62 may provide functionalities to support PDCP layer, SDAP layer and RRC layer.

### Radio Unit (RU)

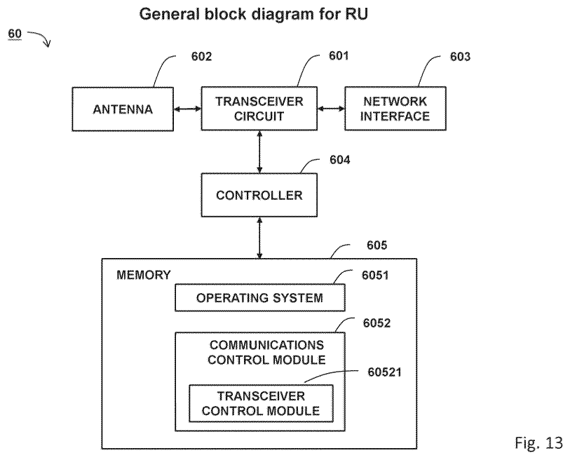

FIG. 13 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (e.g. a removable memory device (RMD)), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

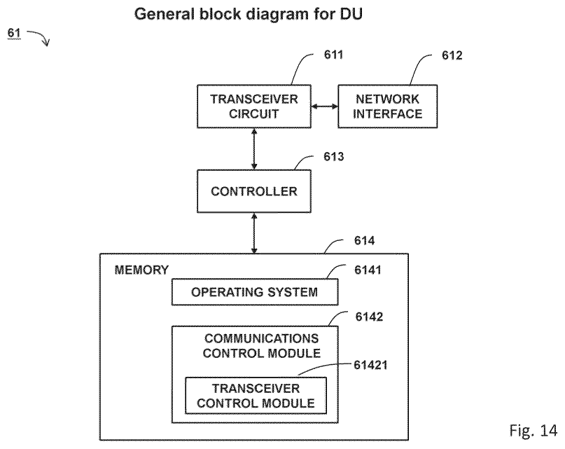

FIG. 14 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (e.g. a removable memory device (RMD)), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the DU 61 can be integrated/combined with the RU 60 or CU 62 as an integrated/combined unit. Any functionality in the description for DU 61 can be implemented in one of the integrated/combined unit above.

### Centralized Unit (CU)

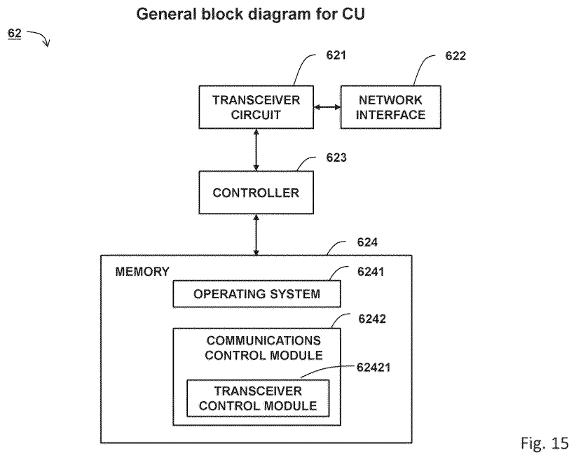

FIG. 15 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (e.g. a removable memory device (RMD)), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### AMF

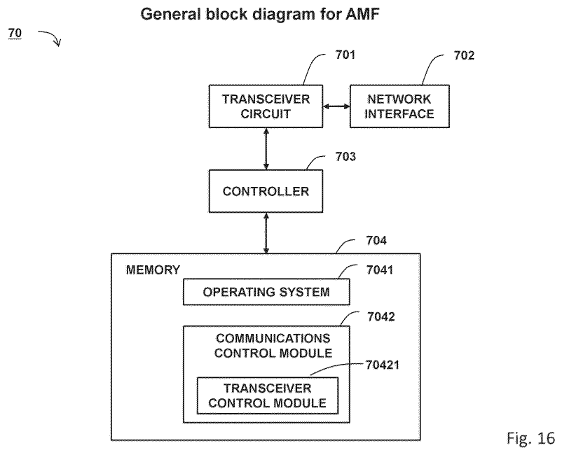

FIG. 16 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (e.g. a removable memory device (RMD)), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R) AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### SMF

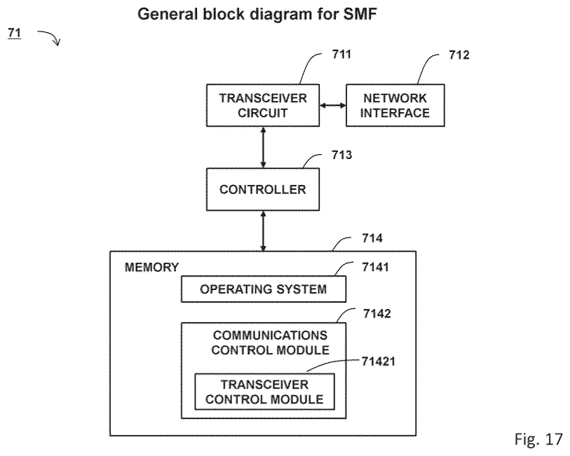

FIG. 17 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### UPF

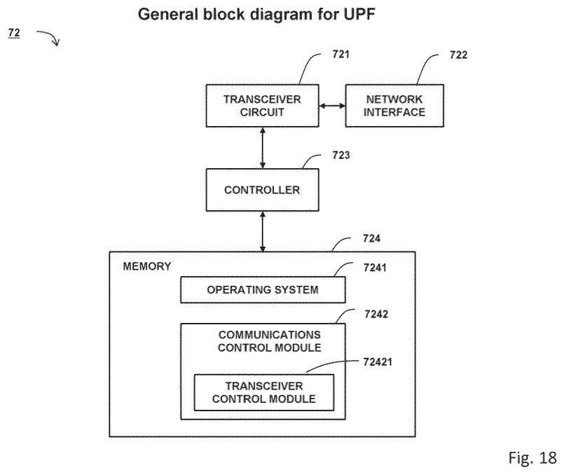

FIG. 18 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### PCF

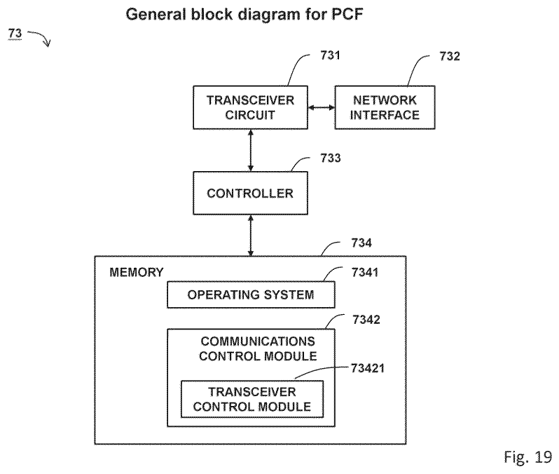

FIG. 19 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### NEF

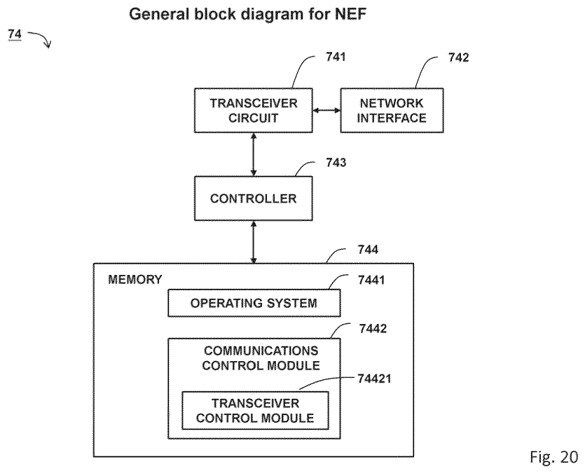

FIG. 20 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the NEF 74 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### UDM

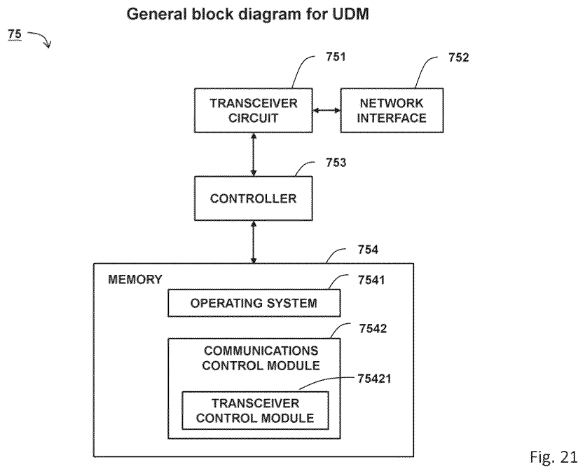

FIG. 21 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (e.g. a removable memory device (RMD)), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### NWDAF

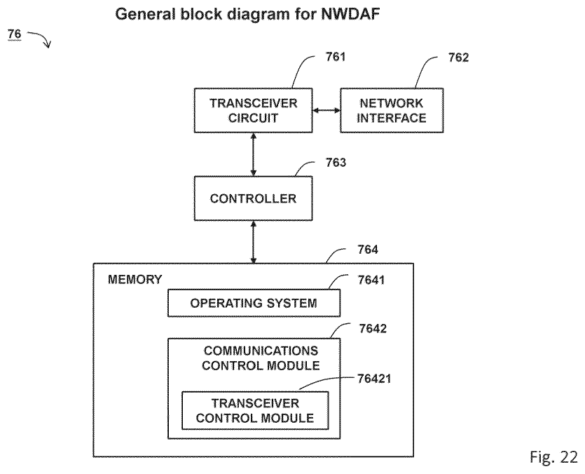

FIG. 22 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); Input/Output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

### (Supplementary Notes)

The whole or part of the example Aspects disclosed above can be described as, but not limited to, the following supplementary notes.

### (Supplementary Note 1)

A method for a first node of Access and Mobility Management in a first network, the method comprising:
receiving, from a second node of Access and Mobility Management included in a second network, a value indicating the number of first User Equipments (UEs) allowed to register the second network per unit time;
transmitting, to at least one second UE among third UEs registered to the first network, a first message to de-register from the first network,
wherein the number of the third UEs is equal to or less than the number of the first UEs.

### (Supplementary Note 2)

The method according to Supplementary note 1,
wherein the transmitting the first message is transmitted within the unit time;
wherein the method further comprising:
transmitting, to at least one forth UE among fifth UEs registered to the first network, a second message to de-register from the first network,
wherein the second message includes a first indication, wherein the first indication indicates a waiting time for waiting to transmit a registration request message to the second node, wherein the waiting time is equal to or more than the unit time,
wherein the fifth UEs are not overlap to the third UEs.

### (Supplementary Note 3)

The method according to Supplementary note 2, wherein the waiting time is different for each of the fifth UEs.

### (Supplementary Note 4)

A method for a first node of Access and Mobility Management in a first network, the method comprising:
receiving, from a User Equipment (UE), a first message including a first indication indicating that waiting a predetermined time to transmit a registration request message to a node of Access and Mobility Management in network is supported at the UE; and
transmitting, to the UE, a second message, wherein the second message requests the UE to wait the predetermined time before transmitting the registration request message to a second node of Access and Mobility Management in a second network.

### (Supplementary Note 5)

The method according to Supplementary note 4, wherein
the second message includes a list indicating identifier (ID) of a Public Land Mobile Network Number (PLMN), wherein the list indicates whether or not the waiting the predetermined time before transmitting the registration request message to each PLMN.

### (Supplementary Note 6)

A method for a first node of Access and Mobility Management in a first network, the method comprising:
receiving, from a UE, a registration request message for temporarily use a service of the first network;
calculating a modified service end time based on information of the UE and a service end time of the service, wherein the information of the UE is independent for each UEs; and
transmitting, to the UE, a de-registration message based on the modified service end time.

### (Supplementary Note 7)

The method according to Supplementary note 6, further comprising:
calculating a first modified service end time based on first information of a first UE and a first service end time of the service for the first UE;
calculating a second modified service end time based on second information of a second UE and a second service end time of the service for the second UE;
transmitting, to the first UE, a first de-registration message based on the first modified service end time; and
transmitting, to the second UE, a second de-registration message based on the second modified service end time,
wherein the first modified service end time and the second modified service end time are different.

### (Supplementary Note 8)

A method for a second node of Access and Mobility Management in a second network, the method comprising:
receiving, from a first node of Access and Mobility Management in a first network, a subscribe message for a value indicating the number of first User Equipments (UEs) allowed to register the second network per unit time;
transmitting, to the first node, the value indicating the number of first UEs allowed to register the second network per unit time; and
receiving, from at least one second UE among third UEs registered to the first network, a registration request message within the unit time, wherein the at least one second UE is de-registered from the first network within the unit time, wherein the number of the third UEs is equal to or less than the number of the first UEs.

### (Supplementary Note 9)

A method for a User Equipment (UE), the method comprising:
receiving, from a first node of Access and Mobility Management in first network, a second message to de-register from the first network, wherein the second message includes a first indication, wherein the first indication indicates a time for waiting to transmit a registration request message to a second node of Access and Mobility Management in second network; and
transmitting, to the second node, the registration request message after waiting the time.

### (Supplementary Note 10)

A method for a User Equipment (UE), the method comprising:
transmitting, to a first node of Access and Mobility Management in first network, a first message including a first indication indicating that waiting a predetermined time to transmit a registration request message to a node of Access and Mobility Management in network is supported at the UE; and
receiving, from the first node, a second message, wherein the second message requests the UE to wait the predetermined time before transmitting the registration request message to a second node of Access and Mobility Management in a second network.

### (Supplementary Note 11)

A first node of Access and Mobility Management in a first network, comprising:
a memory storing instructions; and
at least one hardware processor configured to process the instructions to:
receive, from a second node of Access and Mobility Management included in a second network, a value indicating the number of first User Equipments (UEs) allowed to register the second network per unit time;
transmit, to at least one second UE among third UEs registered to the first network, a first message to de-register from the first network,
wherein the number of the third UEs is equal to or less than the number of the first UEs.

### (Supplementary Note 12)

A first node of Access and Mobility Management in a first network, the first node comprising:
a memory storing instructions; and
at least one hardware processor configured to process the instructions to:
receive, from a User Equipment (UE), a first message including a first indication indicating that waiting a predetermined time to transmit a registration request message to a node of Access and Mobility Management in network is supported at the UE; and
transmit, to the UE, a second message, wherein the second message requests the UE to wait the predetermined time before transmitting the registration request message to a second node of Access and Mobility Management in a second network.

### (Supplementary Note 13)

A first node of Access and Mobility Management in a first network, the first node comprising:
a memory storing instructions; and
at least one hardware processor configured to process the instructions to:
receive, from a UE, a registration request message for temporarily use a service of the first network;
calculate a modified service end time based on information of the UE and a service end time of the service, wherein the information of the UE is independent for each UEs; and
transmit, to the UE, a de-registration message based on the modified service end time.

### (Supplementary Note 14)

A second node of Access and Mobility Management in a second network, the second node comprising:
a memory storing instructions; and
at least one hardware processor configured to process the instructions to:
receive, from a first node of Access and Mobility Management in a first network, a subscribe message for a value indicating the number of first User Equipments (UEs) allowed to register the second network per unit time;
transmit, to the first node, the value indicating the number of first UEs allowed to register the second network per unit time; and
receive, from at least one second UE among third UEs registered to the first network, a registration request message within the unit time, wherein the at least one second UE is de-registered from the first network within the unit time, wherein the number of the third UEs is equal to or less than the number of the first UEs.

### (Supplementary Note 15)

A User Equipment (UE) comprising:
a memory storing instructions; and
at least one hardware processor configured to process the instructions to:
receive, from a first node of Access and Mobility Management in first network, a second message to de-register from the first network, wherein the second message includes a first indication, wherein the first indication indicates a time for waiting to transmit a registration request message to a second node of Access and Mobility Management in second network; and
transmit, to the second node, the registration request message after waiting the time.

### (Supplementary Note 16)

A User Equipment (UE) comprising:
a memory storing instructions; and
at least one hardware processor configured to process the instructions to:
transmit, to a first node of Access and Mobility Management in first network, a first message including a first indication indicating that waiting a predetermined time to transmit a registration request message to a node of Access and Mobility Management in network is supported at the UE; and
receive, from the first node, a second message, wherein the second message requests the UE to wait the predetermined time before transmitting the registration request message to a second node of Access and Mobility Management in a second network.

This application is based upon and claims the benefit of priority from Indian Patent Application number 202211044606, filed on Aug. 4, 2022, the disclosure of which is incorporated herein in its entirety by reference.

### REFERENCE SIGNS LIST

20 DATA NETWORK
3 UE
31 TRANSCEIVER CIRCUIT
32 ANTENNA
33 CONTROLLER
34 USER INTERFACE
35 USIM
36 MEMORY
361 OPERATING SYSTEM
362 COMMUNICATIONS CONTROL MODULE
3621 TRANSCEIVER CONTROL MODULE
5 (R) AN NODE
51 TRANSCEIVER CIRCUIT
52 ANTENNA
53 NETWORK INTERFACE
54 CONTROLLER
55 MEMORY
551 OPERATING SYSTEM
552 COMMUNICATIONS CONTROL MODULE
5521 TRANSCEIVER CONTROL MODULE
60 RU
601 TRANSCEIVER CIRCUIT
602 ANTENNA
603 NETWORK INTERFACE
604 CONTROLLER
605 MEMORY
6051 OPERATING SYSTEM
6052 COMMUNICATIONS CONTROL MODULE
60521 TRANSCEIVER CONTROL MODULE
61 DU
611 TRANSCEIVER CIRCUIT
612 NETWORK INTERFACE
613 CONTROLLER
614 MEMORY
6141 OPERATING SYSTEM
6142 COMMUNICATIONS CONTROL MODULE
61421 TRANSCEIVER CONTROL MODULE
62 CU
621 TRANSCEIVER CIRCUIT
622 NETWORK INTERFACE
623 CONTROLLER
624 MEMORY
6241 OPERATING SYSTEM
6242 COMMUNICATIONS CONTROL MODULE
62421 TRANSCEIVER CONTROL MODULE
7 CORE NETWORK
70 AMF
701 TRANSCEIVER CIRCUIT
702 NETWORK INTERFACE
703 CONTROLLER
704 MEMORY
7041 OPERATING SYSTEM
7042 COMMUNICATIONS CONTROL MODULE
70421 TRANSCEIVER CONTROL MODULE
71 SMF
711 TRANSCEIVER CIRCUIT
712 NETWORK INTERFACE
713 CONTROLLER
714 MEMORY
7141 OPERATING SYSTEM
7142 COMMUNICATIONS CONTROL MODULE
71421 TRANSCEIVER CONTROL MODULE
72 UPF
721 TRANSCEIVER CIRCUIT
722 NETWORK INTERFACE
723 CONTROLLER
724 MEMORY
7241 OPERATING SYSTEM
7242 COMMUNICATIONS CONTROL MODULE
72421 TRANSCEIVER CONTROL MODULE
73 PCF
731 TRANSCEIVER CIRCUIT
732 NETWORK INTERFACE
733 CONTROLLER
734 MEMORY
7341 OPERATING SYSTEM
7342 COMMUNICATIONS CONTROL MODULE
73421 TRANSCEIVER CONTROL MODULE
74 NEF
741 TRANSCEIVER CIRCUIT
742 NETWORK INTERFACE
743 CONTROLLER
744 MEMORY
7441 OPERATING SYSTEM
7442 COMMUNICATIONS CONTROL MODULE
74421 TRANSCEIVER CONTROL MODULE
75 UDM
751 TRANSCEIVER CIRCUIT
752 NETWORK INTERFACE
753 CONTROLLER
754 MEMORY
7541 OPERATING SYSTEM
7542 COMMUNICATIONS CONTROL MODULE
75421 TRANSCEIVER CONTROL MODULE
76 NWDAF
761 TRANSCEIVER CIRCUIT
762 NETWORK INTERFACE
763 CONTROLLER
764 MEMORY
7641 OPERATING SYSTEM
7642 COMMUNICATIONS CONTROL MODULE
76421 TRANSCEIVER CONTROL MODULE

What is claimed is:

1. A method of an Access and Mobility Management Function (AMF) in a network that provides access to a localized service comprising:
performing registration with a plurality of User Equipments (UEs) for the localized service; and
controlling a deregistration of part of the plurality of UEs, in a case where the localized service is ended.

2. The method according to claim 1,
wherein the controlling the deregistration includes sending a deregistration request message to the part of the plurality of UEs.

3. A method of a User Equipment (UE) comprising:
performing registration with an Access and Mobility Management Function (AMF) in a network that provides access to a localized service to a plurality of UEs that includes the UE; and
performing a deregistration with the AMF, in a case where the localized service is ended,
wherein the deregistration is performed with part of the plurality of UEs.

4. The method according to claim 3,
wherein the performing the deregistration includes receiving a deregistration request message, and
wherein the deregistration request message is received by the part of the plurality of UEs.

5. An Access and Mobility Management Function (AMF) in a network that provides access to a localized service comprising:
at least one memory configured to store instructions; and
at least one processor configured to execute the instructions to:
perform registration with a plurality of User Equipments (UEs) for the localized service; and
control a deregistration of part of the plurality of UEs, in a case where the localized service is ended.

6. The AMF according to claim 5,
wherein the performing the deregistration includes receiving a deregistration request message, and
wherein the deregistration request message is received by the part of the plurality of UEs.

7. (canceled)

8. (canceled)
